(19) United States
(12) Patent Application Publication
(10) Pub. No.: US 2020/0082361 A1
(43) Pub. Date: Mar. 12, 2020

(54) SYSTEM AND METHOD FOR CONTROLLING A LEDGER OF TRANSACTIONS

(71) Applicant: Hong Kong R&D Centre for Logistics and Supply Chain Management Enabling Technologies Limited, Pok Fu Lam (HK)

(72) Inventors: Chun Fai Chan, Pok Fu Lam (HK); Chung Dak Shum, Pok Fu Lam (HK); Arafet Ben Makhlouf, Pok Fu Lam (HK)

(21) Appl. No.: 16/493,885

(22) PCT Filed: Mar. 16, 2017
(86) PCT No.: PCT/CN2017/076912

§ 371 Date: Sep. 13, 2019

(51) Int. Cl. G06Q 20/06; H04L 9/32

(52) U.S. Cl. CPC G06Q 20/065; H04L 2209/38; H04L 9/3247

(57) ABSTRACT

A computer implemented method for controlling a ledger of transactions, the method comprising the steps of adding an entry of one or more privileged users into the ledger of transactions, the entry being embedded within the ledger of transactions, adding one or more keys associated with the one or more privileged user to the ledger of transactions, wherein the ledger of transactions is a non permissioned ledger and wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions.

### TECHNICAL FIELD

The present disclosure relates to a system and a method for controlling a ledger of transactions in digital property transfer. In particular the present disclosure relates to a system and a method for controlling an electronic ledger of transactions, such as a blockchain, in digital property transfer.

### BACKGROUND

Digital property such as virtual currencies or cryptocurrencies may be traded through a peer-to-peer (P2P) mediums or peer-to-peer (P2P) computer networks. Bitcoin is one example of a cryptocurrency that uses a P2P computer networks to trade bitcoin. The transactions are generally verified by network nodes and recorded in a public ledger called a blockchain. The blockchain or public ledger maintains a record of all transactions related to a particular cryptocurrencies. The blockchain and use of cryptocurrencies, such as Bitcoin, are open to anyone from the general public.

The blockchains or public ledgers are generally permissionless and can be used by any person. Some examples of open cryptocurrencies that use public blockchains or ledgers are Bitcoin or Ethereum. These public blockchains use a proof of work based ledger where all or majority of the network nodes need to mathematically confirm a transaction in order to add a new block into the blockchain. Each block relates to one or more transactions. There is no central control authority, such as central banks or retail banks, that control which transactions are registered to the blockchain or ledger of a cryptocurrency. For example banks or other regulators may have lower hashing power than other nodes in the P2P network. Further mining different blocks or random blocks concurrently can lead to higher forking rates in the P2P network.

Certain types of cryptocurrencies use a permissioned ledger or bitcoin. Some examples are Hyperledger or Ripple/Stellar and so on. These cryptocurrencies may use another suitable method to update the blockchain, such as for example Byzantine Fault Tolerance (BFT). These permissioned blockchains or ledgers support a set of privileged users that are authorized to modify or amend the blockchain or ledger. An issue with using a permissioned ledger or a permissioned blockchain is the reduced flexibility to support a dynamic membership quorum or group of decision makers. There is a need for a ledger of transactions, such as a blockchain, that is open (i.e. permissionless) but also has some form of permissions.

### SUMMARY OF THE INVENTION

The present disclosure relates to a system and a method for controlling a ledger of transactions in digital property transfer. In particular the present disclosure relates to a system and a method for controlling a ledger of transactions, such as a blockchain, in digital property transfer such as cryptocurrency transfer or cyptocurrency transactions. The system and method of controlling a ledger of transactions as described herein, in particular with respect to an electronic ledger of transactions, is implemented using one or more computers or other such programmable electronic devices. It is an object of the present disclosure to describe a system and method of controlling an electronic ledger of transactions that ameliorate one or more of the deficiencies described in the prior art, or at least provide the public with a useful choice.

In accordance with a first aspect, the present disclosure provides, a computer implemented method for controlling a ledger of transactions, the method comprising the steps of:

adding an entry of one or more privileged users into the ledger of transactions, the entry being embedded within the ledger of transactions,

adding one or more keys associated with the one or more privileged user to the ledger of transactions, wherein the ledger of transactions is a non permissioned ledger and;

wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions.

In an embodiment the entry comprises a list of a plurality of privileged users, and wherein the plurality of privileged users can validate a transaction to be added into ledger of transactions.

In an embodiment the ledger of transactions includes a record of all transactions occurring across a distributed network, the transactions are ordered in chronological order within the ledger of transactions,

the ledger of transactions is a blockchain, wherein the blockchain comprises a plurality of blocks,

wherein each block includes a record of one or more transactions and a date stamp, the blocks being arranged in the blockchain in a chronological order based on the date stamp.

In an embodiment the entry comprises a list of a plurality of privileged users, the entry further comprises a level of authority of each of the plurality of privileged users.

In an embodiment the method comprises the steps of;

receiving one or more transactions, each transaction being defined in a transaction request from a user, the transactions being received by the one or more of the privileged users,

validating each transaction, wherein each transaction being validated by at least one privileged user of the one or more privileged users,

collating a plurality of validated transactions into a block, wherein the block comprises at least a plurality of transactions and a digital signature from the at least one privileged user of the one or more privileged users.

In an embodiment the digital signature of the at least one privileged user being included in at least a first transaction of the block and including the one or more keys associated with the one or more privileged users, and wherein at least the digital signature is embedded within an unused portion of the transaction.

In an embodiment the method comprises the additional steps of:

providing one or more blocks to a network of a plurality of nodes,

two or more of the plurality of nodes from the network verifying each block, each node configured to execute a mathematical protocol to verify each block, the network comprising nodes corresponding to the privileged users and other users,

adding a verified block into the blockchain.

In an embodiment the step of verifying each block comprises each node checking that the block includes a valid electronic signature and checking if one or more keys included in the block relates to one or more of the privileged users included in the ledger of transactions.

In an embodiment the ledger of transactions is a blockchain, the blockchain comprises a genesis block, the genesis block functioning as an electronic token, the token including an entry of the plurality of privileged users and wherein the entry is a list of the plurality of privileged users.

In an embodiment the method comprises amending a the list of the privileged users to add or remove a privileged user from the list of privileged users, wherein a node corresponding to the one or more privileged users is configured to amend the list of privileged users,

transmitting the amended list of privileged users to all the nodes in the network,

updating a database of keys at each node within the network, wherein the database of keys includes a record of an identity of the current privileged users or public keys of a current list of privileged users and wherein the database of keys is updated to correspond to the amendments made to the list of privileged users.

In an embodiment the step of verifying a block further comprises the additional step of a node checking the identity of a signature and the identity of the keys included in the block, and wherein the identity of the signature and identity of keys being related to the record in the database stored at the nodes.

In an embodiment the step of amending the list of privileged users comprises the additional steps creating at least a new transaction that includes the amended list of privileged users,

transmitting the new transaction across the network of nodes, and wherein each node is configured to execute the step of updating the database at each node as the transaction is received at each node.

In an embodiment the new transaction is a coinbase transaction of a new block, and wherein the new block including the amended list of privileged users is transmitted to the nodes in the network.

In an embodiment the one or more keys added to the entry in the ledger of transactions are public keys that correspond to the one or more privileged user,

the coinbase transaction is spendable by a privileged user based on one or more signatures within the coinbase transaction, and;

the coinbase transaction specifying a threshold or quorum required to validate a transaction or update the list of privileged users.

In accordance with a second aspect the present disclosure relates to a system for controlling a ledger of transactions, the system comprising:

one or more privileged user devices, each device being associated with a privileged user, the one or more privileged user devices configured to add an entry of one or more privileged users into the ledger of transactions, the entry being embedded within the ledger of transactions,

the one or more privileged user devices configured add one or more keys associated with the one or more privileged user to an entry in the ledger of transactions,

wherein the ledger of transactions is a non permissioned ledger, and wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions.

In an embodiment the entry comprises a list of a plurality of privileged users, and wherein the plurality of privileged user devices can validate a transaction to be added into the ledger of transactions.

In an embodiment the ledger of transactions includes a record of all transactions occurring across a distributed network, the transactions are ordered in chronological order within the ledger of transactions,

the distributed network comprising a plurality of computing devices, each computing device being a node within the network and;

the ledger of transactions is a blockchain wherein the blockchain comprises a plurality of blocks, each block includes a record of one or more transactions and a data stamp.

In an embodiment the entry comprises a list of a plurality of privileged users, the entry further comprises a level of authority of each of the plurality of privileged user.

In an embodiment the one or more privileged user devices receiving one or more transaction requests from a user wherein each transaction request includes one or more transactions,

the one or more privileged user devices configured to validate each transaction, wherein each transaction being validated by at least one privileged user device of the one or more privileged users device,

the one or more privileged user devices configured to collate a plurality of validated transactions into a block, wherein the block comprises a plurality of transactions and a digital signature from the one or more privileged users that validated the transaction.

In an embodiment the privileged user device configured to include digital signature of the at least one privileged user being included in at least a first transaction of the block and the privileged user device configured to include the one or more keys associated with the one or more privileged users that validated the first transaction, and wherein at least the digital signature is included in an unused portion of the first transaction.

In an embodiment the one or more privileged user devices are configured to provide the one or more blocks to a network of a plurality of nodes, the network comprises nodes that correspond to the privileged user devices and nodes that correspond to other user devices, wherein the privileged user devices and other user devices,

each node comprises a computing device,

two or more of the plurality of nodes from the network configured to verify each block received in the network, and each computing device corresponding to each node configured to execute a mathematical protocol to verify each block,

the one or more nodes in the network configured to add a verified block into the blockchain.

In an embodiment each computing device associated with the node within the network configured to check that the block includes a valid electronic signature, each node within the network configured to check if one or more keys included in the block relates to one or more of the privileged users.

In an embodiment the ledger of transactions is a blockchain, the blockchain comprising a plurality of blocks being arranged in a chronological order, the blockchain is an electronic ledger of transactions, the blockchain comprising a genesis block, wherein the genesis block functions as an electronic token, the token including an entry of the plurality of privileged users and wherein the entry is a list of the plurality of users.

In an embodiment the electronic token being included in the blockchain, the computing devices associated with the other users in the network configured to receive the electronic token and the computing devices associated with the other users in the network configured to verify each block.

In an embodiment one or more privileged user devices configured to amend the list of the privileged users by adding or removing a privileged user from the list of privileged users, the one or more privileged user devices configured to transmit the amended list of privileged users to all the nodes in the network,

the other user devices within the network configured to updated a database of keys, wherein each other user device comprises an associated database of keys that includes a record of an identify of the current privileged users and/or public keys associated with the current list of privileged users, and wherein the database of keys is updated to correspond to the amendments made to the list of privileged users.

In an embodiment the computing device corresponding to a node configured to check the identity of a signature and the identity of the keys included in the block as part of verifying a block, and wherein the identity of the signature and identity of keys being related to the record in the database stored on a computing device corresponding to a node.

In an embodiment one or more privileged user devices being configured to amend the list of privileged users by creating a new transaction that includes the amended list of privileged,

the one or more privileged user devices configured to transmit the new transaction across the network of nodes, wherein each computing device corresponding to a node in the network configured to updated an associated database as the transaction is received at each computing device.

In an embodiment the new transaction is a coinbase transaction of a new block, and wherein the new block including the amended list of privileged users is transmitted to the nodes in the network.

In an embodiment the one or more keys added to the entry in the ledger of transactions are public keys that correspond to the one or more privileged user,

the coinbase transaction is spendable by a privileged user via a privileged user device based on one or more signatures within the coinbase transaction, and;

the coinbase transaction specifying a threshold or quorum required to validate a transaction or update the list of privileged users.

In this specification, the word “comprising” and its variations, such as “comprises”, has its usual meaning in accordance with International patent practice. That is, the word does not preclude additional or unrecited elements, substances or method steps, in addition to those specifically recited. Thus, the described apparatus, substance or method may have other elements, substances or steps in various embodiments of the invention. The purpose of the claims is to define the features which make up the invention and not necessarily all features which a working embodiment of the apparatus, substance or method, to which the invention defines, may have. The apparatus, substance or method defined in the claims may therefore include other elements, steps or substances as well as the inventive elements, steps or substances which make up the invention and which are specifically recited in the claims.

### BRIEF DESCRIPTION OF THE DRAWINGS

FIG. 1 illustrates an embodiment of a system for controlling a ledger of transactions for digital property transfer.

FIG. 2 illustrates a computing device that can be used as part of the system for controlling a ledger of transactions for digital property transfer.

FIG. 3 shows a block diagram of adding a digital signature from a privileged user in order to validate one or more transactions.

FIG. 4 shows a block diagram of an exemplary Merkle Hash tree used within a block of a ledger of transactions.

FIG. 5 shows a schematic of an exemplary coinbase transaction within a ledger of transactions.

FIG. 6 shows a schematic diagram for updating a record of privileged users within one or more blocks of a ledger of transactions.

FIG. 7 shows an example input and output for a new transaction to update a list of privileged users.

FIG. 8 shows a method of controlling a ledger of transactions for the transfer of digital property.

FIG. 9 shows a method of amending a list of privileged users within a system for controlling an electronic ledger or transactions.

### DETAILED DESCRIPTION OF A PREFERRED EMBODIMENT

The transactions are generally verified by network nodes and recorded in a public ledger called a blockchain. The blockchains or public ledgers are generally permissionless and can be used by any person. These public blockchains use a proof of work based ledger where all or majority of the network nodes need to mathematically verify or confirm a transaction in order to add a new block into the blockchain. Each block relates to one or more transactions. There is no central control authority, such as central banks or retail banks, which control which transactions are registered to the blockchain or ledger of a cryptocurrency. However for security reasons, safety, and reliability reasons there is a need to be able to control the ledger of transactions and control inputs to the ledger.

The present disclosure relates to a system and a method for controlling a ledger of transactions in digital property transfer. In particular the present disclosure relates to a system and a method for controlling a ledger of transactions, such as a blockchain, in digital property transfer. Digital currency is one form of digital property that is becoming more commonly used and is becoming more accepted as a mainstream way of payment for goods and services. Digital currency, such as Bitcoin, is one example of digital property that can be transfer from one person using computers or a computer network comprising a plurality of computers.

In an embodiment the present disclosure relates to a computer implemented method for controlling a ledger of transactions, the method comprising the steps of: adding an entry of one or more privileged users into the ledger of transactions, the entry being embedded within the ledger of transactions, adding one or more keys associated with the one or more privileged user to an entry in the ledger of transactions, wherein the ledger of transactions is a non permissioned ledger and; wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions. The entry comprises a list of a plurality of privileged users, and wherein the plurality of privileged users can validate a transaction to be added into ledger of transactions. The ledger of transactions includes a record of all transactions occurring across a distributed network, the transactions are ordered in chronological order within the ledger of transactions, and the ledger of transactions is a blockchain, wherein the blockchain comprises a plurality of blocks, wherein each block includes a record of one or more transactions and a date stamp, the blocks being arranged in the blockchain in a chronological order based on the date stamp. The method further comprises the steps of; receiving one or more transactions, each transaction being defined in a transaction request from a user, the transactions being received by the one or more of the privileged users, validating each transaction, wherein each transaction being validated by at least one privileged user of the one or more privileged users, collating a plurality of validated transactions into a block, wherein the block comprises at least a plurality of transactions and a digital signature from the at least one privileged user of the one or more privileged users.

In an embodiment the present disclosure relates to a non transitory computer readable medium for controlling a ledger of transactions, comprising instructions stored thereon, that when executed on or by a processor, cause at least the processor to execute the steps of: adding an entry of one or more privileged users into the ledger of transactions, the entry being embedded within the ledger of transactions, adding one or more keys associated with the one or more privileged user to an entry in the ledger of transactions, wherein the ledger of transactions is a non permissioned ledger and; wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions. The processor and the non transitory computer readable medium may form part of privileged user device such as a programmable computer. The non transitory computer readable medium for controlling a ledger of transactions, further comprising instructions stored thereon, that when executed on or by a processor, cause the processor to execute the further steps of; receiving one or more transactions, each transaction being defined in a transaction request from a user, the transactions being received by the one or more of the privileged users, validating each transaction, wherein each transaction being validated by at least one privileged user of the one or more privileged users, collating a plurality of validated transactions into a block, wherein the block comprises at least a plurality of transactions and a digital signature from the at least one privileged user of the one or more privileged users.

In a further embodiment the present disclosure relates to a system for to controlling a ledger of transactions, the system comprising: one or more privileged user devices, each device being associated with a privileged user, the one or more privileged user devices configured to add an entry of one or more privileged users into the ledger of transactions, the entry being embedded within the ledger of transactions, the one or more privileged user devices configured add one or more keys associated with the one or more privileged user to an entry in the ledger of transactions, wherein the ledger of transactions is a non permissioned ledger, and wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions. The entry comprises a list of a plurality of privileged users, and wherein the plurality of privileged user devices can validate a transaction to be added into the ledger of transactions. The ledger of transactions includes a record of all transactions occurring across a distributed network, the transactions are ordered in chronological order within the ledger of transactions, the distributed network comprising a plurality of computing devices, each computing device being a node within the network and; the ledger of transactions is a blockchain wherein the blockchain comprises a plurality of blocks, each block includes a record of one or more transactions and a data stamp. The one or more privileged user devices receiving one or more transaction requests from a user wherein each transaction request includes one or more transactions, the one or more privileged user devices configured to validate each transaction, wherein each transaction being validated by at least one privileged user device of the one or more privileged users device, the one or more privileged user devices configured to collate a plurality of validated transactions into a block, wherein the block comprises a plurality of transactions and a digital signature from the one or more privileged users that validated the transaction.

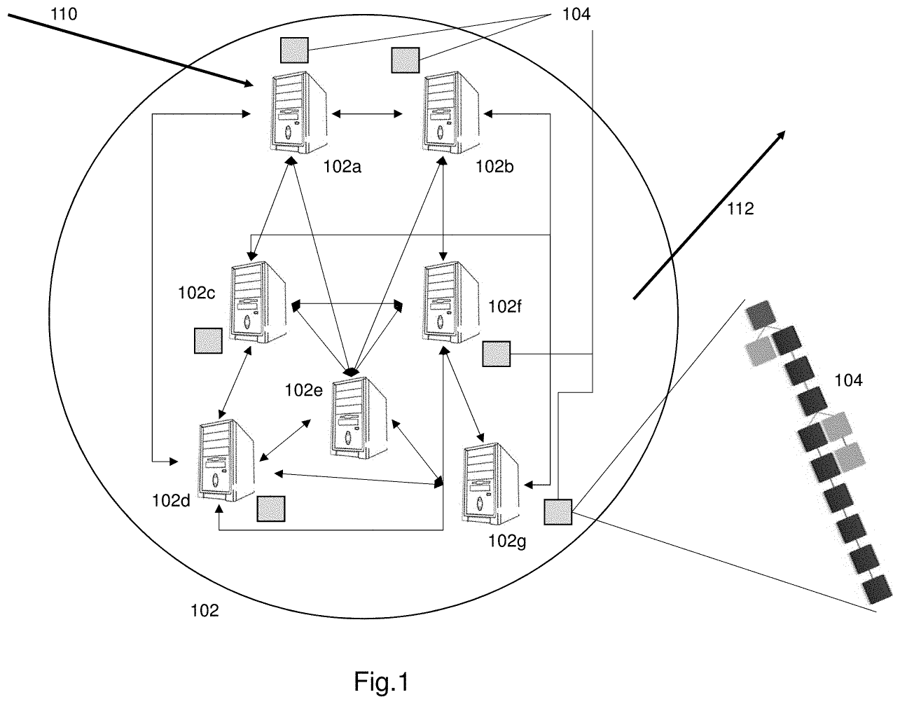

Exemplary embodiments will now be described with respect to the figures. FIG. 1 shows a non-limiting, exemplary embodiment of a system 100 for controlling a ledger of transactions. The ledger of transactions is an electronic ledger and is used to keep a track of a plurality of transactions. The system 100 comprises a network 102 of nodes 102a, 102b, 102c, 102d, 102e, 102f, 102g (102a-102g). The nodes 102a-102g within the network are linked to each other and arranged to be in communication with each other. The nodes 102a-102g may be in wireless communication with each other. Alternatively the nodes 102a-102g may be in wired communication or wired connection with each other.

The network 102 is a peer to peer network that is utilized to execute and verify transfer of digital property, wherein the transfer of digital property is known as a transaction. In the present disclosure the digital property is digital currency. The present disclosure uses bitcoin as the exemplary digital property that can be transferred between users or nodes of the network, and the systems and methods described herein are described with reference to bitcoin as the digital property being transferred. The presently described systems and methods can be applicable to other forms of digital currency or other forms of digital property.

Each node within the network 102 is a computing device that includes at least a processor and a memory unit to store instructions that can be executed to cause the processor to perform various tasks. New nodes can be added to the network 102 or existing nodes can be deleted from the network 102. The nodes are connected via the internet or another suitable communication network. For example a node can be added when a person downloads appropriate software on their computing device, wherein the software facilitates an electronic connection to the network 102. The software also facilitates a download of all essential information required by the node to function within the network.

Each node 102a-120g corresponds to a user within the network 102. Some of the nodes within the network 102 are associated with privileged users 102a, 102b while the other nodes 102c-102g are correspond to the other users within the network 102. The network 102 is utilized to transfer digital property and record all transactions of digital property, which occur across the network, in a ledger of transactions. The ledger of transactions 104 includes a record of all transactions that have occurred on or within the network. A transaction can only take place between users of the network, therefore the ledger is created by recording the transactions conducted in or on the network by users of the network 102. Each transaction is generally related to a transfer of digital property from one user to another. The ledger of transactions 104 includes a record of all transactions in chronological order. The ledger is used to verify transactions made on the network 102 since the ledger includes all transactions that have taken place on the network 102. The ledger of transactions 104 is an electronic ledger, which in one example is a blockchain. The blockchain 104 comprises a plurality of blocks arranged in a sequential order. The blocks may be arranged in chronological order. Each block within the blockchain 104 comprises details of one or more transactions. One or more transactions that occur on the network can be grouped together and added into a block. Blocks are added to the ledger of transactions 104 (i.e. the blockchain 104) when the block and/or the transactions within the block are verified by all or at least a majority of the nodes in the network.

Each transaction is related to a transfer of digital property from a first party to a second party. The digital property may be an electronic currency or any other suitable digital property. In one example the digital property is bitcoin. A transaction received by the network 102 relates to a transfer of digital property. FIG. 1 shows an incoming transaction 110 that is received from a computer device associated with a transferring party (not shown). Once the transaction is validated and verified, the transaction is recorded in an electronic ledger of transactions 104, and the verified and validated transaction 112 is provided to a receiving party. The transaction 110 and the verified and validated transaction 112 represent a transfer of digital property from a sending party (not shown) to a receiving party (not shown). The ledger 104 is updated as described herein each time a transaction request is received.

Each computing device associated with each node includes a software client that is stored in the memory unit of the computing device. The software client turns a computing device into a node 102a-102g. The software client allows connection to the network 102 and downloads all essential information, such as for example a copy of the ledger 104 onto the computing device associated with the node. Each computing device associated with the node further includes a digital property wallet. In the present disclosure the digital property wallet is a bitcoin wallet. The bitcoin wallet is a software application that is downloaded and stored on a computing device associated a node 102a-102g. Users of the network (i.e. nodes) can send and receive bitcoins using a bitcoin wallet. Bitcoin wallets or other wallets of digital currency or digital property are known technology.

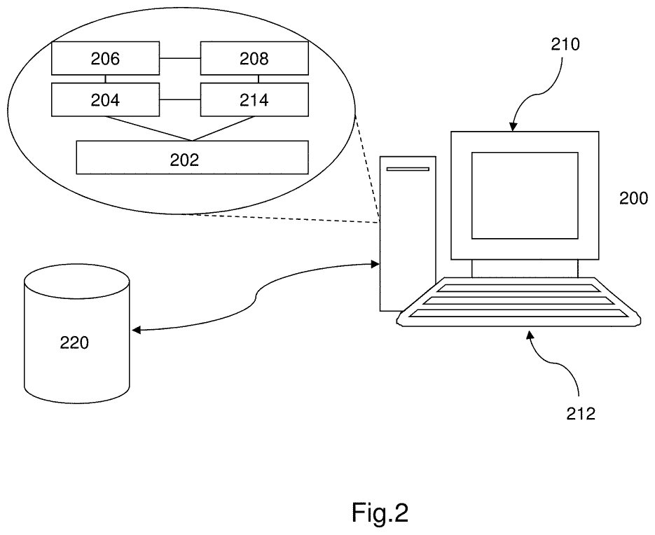

FIG. 2 shows a schematic view of a computing device used to form a node within the network. The computing device 200 described with respect to FIG. 2 is generally used as part of the user device as well as for the privileged user device. The computing device 200 comprises suitable components to receive, store and execute appropriate computer instructions to allow control of an electronic ledger of transactions. The components include a processor 202, read only memory (ROM) 204, random access memory (RAM) 206, and input/output devices such as disk drives 208 or other input devices such as Ethernet ports, USB ports, HDMI ports etc. The computing device 200 may include a display 210 such as an LCD or LED display or any other suitable display. The computing device 200 may optionally include a user interface 212 such as a keyboard or keypad. The computing device 200 further comprises a suitable communications link 214. The communications link 214 allows the computing device 200 to connect to other devices in the network, allows connection to a suitable computer network and may also allow computing device 200 to connect to one or more computing devices such as a server, router, personal computers, terminals, wireless or handheld computing devices or mobile devices.

The computing device 200 includes instructions that may be included in a non transitory computer readable medium such as ROM 204 or RAM 206. The instructions can be executed by the processor 202 and cause the processor to function as a privileged user device or as an other user device. The disk drives 208 may be solid state drives, optical drives or magnetic tape drives. The computing device 200 may also have a suitable operating system which resides in ROM 204, RAM 206 or on a disk drive 208. The computing device 200 may further comprise a database 220 that resides in memory of the computing device or may be remote and accessed by the computing device. The database 220 is a database of keys that may be stored at each device that functions as a node of the network 102. The database of keys 220 includes a record of an identity of the current privileged users within the network. Further database 220 may include a list of public keys associated with the privileged users, wherein the database 220 can be updated to correspond to any amendments made to the list of privileged users.

The computing device acting as a privileged user device may include a first set of instructions stored in memory as software that, when executed by the processor of the privileged device, causes the privileged user device to function as a privileged user and perform the functions described herein. The computing device acting as an other user may include a second set of instructions stored in memory as software that, when executed by the processor of the other user device, causes the other user device to function as an other user device within the network 102.

In a further embodiment the computing device 200 as described may be embodied as a mobile device such as a smartphone or a tablet. The smartphone or tablet can include the components described above with respect to FIG. 2. The mobile device can function as a node in the network 102.

Known blockchains such as a standard blockchain is a proof of work ledger that treats all users of the network as equal. The system 100 for controlling an electronic ledger of transactions provides a platform to convert public ledgers into a ledger with privileged users. The privileged users 102a, 102b have additional authority within the network over other users 102c-102g. The privileged users 102a, 102b have the authority to modify the ledger 104 by determining which transactions are added into the ledger 104. The privileged users 102a, 102b are configured to validate each transaction occurring within the network and validate each block. The privileged users can be any suitable users with increased authority. Some examples of potential privileged users may be retail banks or a central bank or credit card companies or a government regulator such as the FDA or any other suitable finance related institution that may require control over digital property transfers such as exchange of cryptocurrency.

The privileged user devices 102a, 102b (i.e. the computing devices associated with the privileged user nodes), are configured to receive each transaction 110 and validate each transaction received on the network 102. FIG. 1 shows that a transaction received 110 by the network is received or sent to the privileged users 102a, 102b for validation. The privileged user devices 102a, 102b are configured to add an entry of the one or more privileged users (i.e. validators) into the ledger of transactions 104 (i.e. the blockchain 104). The entry is embedded within the ledger 104 (i.e. the blockchain 104). The privileged user devices 102a, 102b are further configured to add one or more keys associated with the one or more privileged user to an entry into the blockchain 104 (i.e. into the ledger). The keys associated with the privileged users 102a, 102b are the public keys associated with the privileged users 102a, 102b. The ledger of transactions 104 is a non permissioned ledger initially. Adding the one or more keys and an entry of the privileged users to the transactions coverts the non permissioned ledger into a permissioned ledger of transactions 104. In the modified protocol or a permissioned ledger 104, only the privileged users defined in the entry of the ledger can validate a transaction to be added to the ledger. The privileged users are required to validate each transaction before it is processed by the other user devices 102a-102g and verified by the other user devices. The other user devices 102c-102g verify the transactions and add the validated transactions into the ledger 104 (i.e. the blockchain 104). As part of the verification process the other user devices 102c-102g are configured to check for a digital signature of or corresponding to a privileged user is included in a transaction or block. The verification process for each block comprises each node 102a-102g checking that the block includes a valid electronic signature and checking if one or more public keys associated with one or more privileged users, are included in the block.

The entry within the ledger comprises a list of a plurality of privileged users. The plurality of privileged users can validate a transaction to be added into the ledger of transactions (i.e. blockchain 104). The entry further comprises a list of privileged users and a level of authority of each of the plurality of the privileged users. In one example each of the privileged users has the same validation authority. In another example the privileged users have difference levels of authority for validation. In this second example certain privileged users may have more authority or explicit authority to validate a transaction or a block. The ledger 104 includes a record of all transactions occurring across the distributed network 102, and the transactions in the ledger 104 are ordered in chronological order. Each block within the blockchain 104 (i.e. ledger 104) includes one or more transactions and a date stamp. The blocks are arranged in the blockchain 104 based on the date stamp. Each block or transaction may also include a time stamp.

The privileged users 102a, 102b receive one or more transaction requests from one or more users 102c-102g. The transaction request defines a transaction. At least one privileged user 102a, 102b validating each transaction. In another example each transaction is received by each privileged user device 102a, 102b. Each privileged user being configured to validate each transaction. The privileged user devices 102a, 102b are configured to collate a plurality of validated transactions into a block, wherein the block comprises at least a plurality of transactions and a digital signature from at least one privileged user. The block preferably comprises a digital signature from each privileged user. The digital signature is generated at the privileged user device by using a private key associated with the privileged user 102a, 102b. The public keys associated with or corresponding to each privileged user are embedded in the block chain and can be used by the other user devices 102c-102g to verify a transaction. The coinbase transaction of a block can be used to hold the privileged user's digital signature. The coinbase transaction is the first transaction in a block. The digital signature may be a string or letters or characters or numerals or any combination thereof. A block is validated when a digital signature from one or more privileged users is entered into the block, via one or more privileged user devices 102a, 102b. A transaction is considered validated if a digital signature is included within a block that holds the transaction.

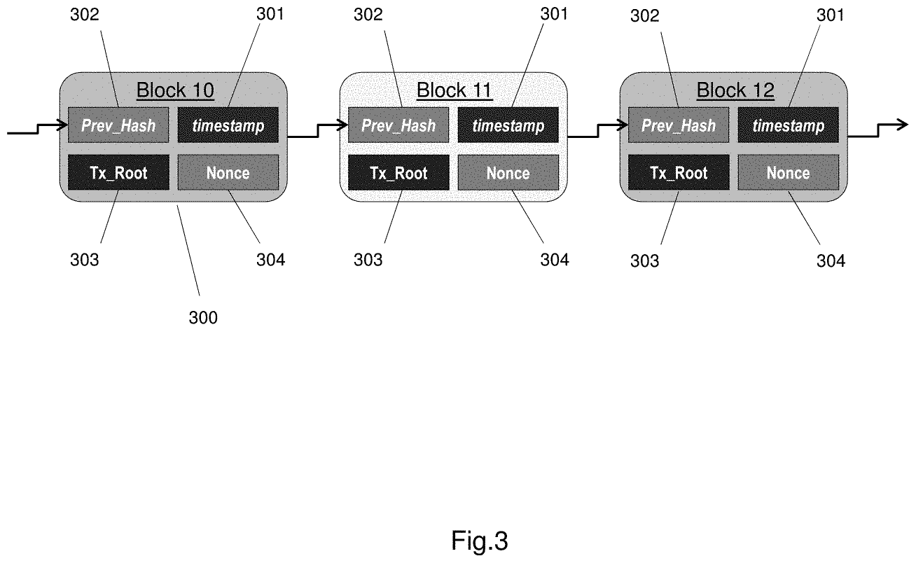

FIG. 3 shows a shows a block diagram of adding a digital signature from a privileged user in order to validate one or more transactions. FIG. 3 shows a plurality of blocks in a block chain. As seen in FIG. 3, three blocks 10, 11 and 12 are illustrated. Each block includes a plurality of information components as shown in FIG. 3. The blocks are identical to each in structure but the actual contents of each block can be different to other blocks in a block chain. Each block includes a timestamp 301, a Prev_Hash component 302, a Tx_Root component 303 and a Nonce component 304.

The timestamp 301 denotes the time when the block was found and verified by the network 102. Each block undergoes a mining process to verify the transactions in the block. The Prev_Hash component 302 is a hash of the previous block header. The Prev_Hash component 302 of each block ties that block to its parent and therefore by induction to all the blocks in the blockchain 104. The Tx_Root component 303 is reduced representation of the set of transactions that is confirmed with the block 300. The transactions themselves are provided independently forming the body of the block 300. The transactions are collated into a block following the validation process, as described earlier. The Nonce component 304 is a random number that adds entropy for verifying a block. The nonce 304 can be used to determine a hash for the block to verify the block. The nonce is used in a known mathematical algorithm to verify the block. The use of a Nonce in a block of a blockchain is well known.

One or more validated blocks are transmitted to the network 102, and to all the users in the network for verification. In an alternative embodiment one or more validated blocks may be transmitted to the other users 102c-102g only for verification. Two or more user devices defining the nodes are configured to verify each block. Each computing device 102a-102g of each node is configured to execute a mathematical protocol or algorithm to verify each block. The mathematical protocol or algorithm is known and comprises determining a hash based on a nonce in a block. The verified block is added to the blockchain. The verification of each block is performed by all the nodes in the network. Alternatively only the privileged user nodes 102a, 102b are configured to perform both the validation and verification steps.

More detail of the validation process will now be described. As part of the validation step each node 102a-102g, of the network 102, is configured to check if the block carries a valid electronic signature from one or more of the privileged users and if the public key corresponding to the signature is associated with the one or more privileged users. Each node may also be configured to hash the block header to provide a correct number of leading zeros in the image. Each node 102a-102g is configured to check if each block carries a valid signature for the root has of a Merkle tree associated with the block. A new block is added to the blockchain if both the privileged users 102a, 102b and the other users 102c-102g consent i.e. verify the block. The blockchain includes a list of the public keys used by the privileged users to validate each block. These public keys can be looked up within the blockchain by any node 102a-102g as part of the verification process, and hence there is no additional certification required for these public keys. This improves processing time as the size of the blocks are reduced and there is no additional certification step required.

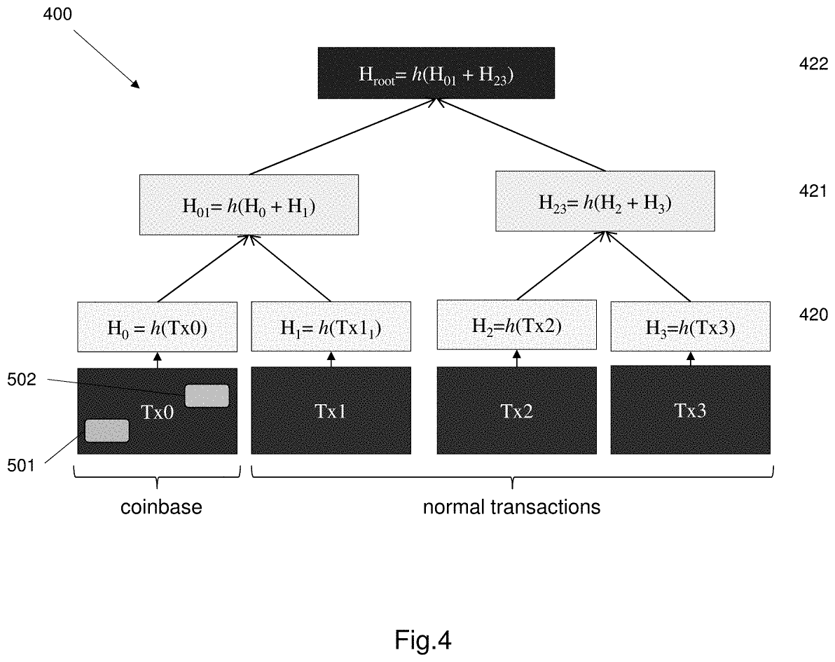

As described earlier the privileged user, e.g. a bank checks all transactions in a block and verifies their signatures from a sender. The privileged user validates each transaction as described earlier. Validated transactions are collated into a block and the digital signature is included in the block 300. A merkle tree is formed over all transactions in the block 300. The Tx_Root comprises the merkle tree. The privileged user signature signature and public key is put in the coinbase transaction of the block, after the merkle tree is formed. The computing device of the privileged user 102a, 102b comprises stored instructions that allow the processor of the privileged user device to create a merkle tree. The nodes 102a-102g mine the blocks on the root hash of the merkle tree. Mining is the process of verifying a block and the transactions within the block. FIG. 4 shows an example of a Merkle tree 400. The Merkle tree includes multiple levels wherein each of the transactions is hashed using a known hashing process or technique. The lowest level 410 includes transactions. Tx0 is the coinbase transaction i.e. the first transaction in a block. Tx1 to Tx3 as shown in FIG. 4 are further transactions that are to be included in the block. A hash for each transaction is developed as part of creating the Merkle tree 400. Each transaction is hashed. The hash of each transaction is shown in FIG. 4 and labelled H0, H1, H2, H3. H0 relates to the hash of the coinbase transaction Tx0. Each hash is paired with an adjacent hash and hashed again. The second level 420 shows a first hashed pair 421 and a second hashed pair 422. The pairing and hashing process is repeated until a final block i.e. a root hash is developed. FIG. 4 shows Hroot is a hash of the hash pairs in a lower level.

The signature of the privileged user is added to the coinbase transaction of each block. Each transaction includes at least an input and at least an output. The signature of one or more privileged users may be added either in the scriptSig of the input if there is a single signature to be added. The scriptSig data element is generally 100B max in size is unused for the coinbase transaction as the coinbase transaction is the first transaction. Generally the coinbase transaction input is unused. However in the current system and method for controlling an electronic ledger of transactions, the input of the coinbase transaction can include the signatures of privileged users. The public key of the privileged user can be included into the scriptSig data element if there is a single key to be added. Alternatively if there are multiple signatures and multiple public keys to be included in a block, a different data element is used to store the multiple signatures and public keys. For example the if there are multiple signatures required by a single privileged user or multiple signatures from a plurality of privileged users, the OP_Return output is used to store the signatures and the public keys.

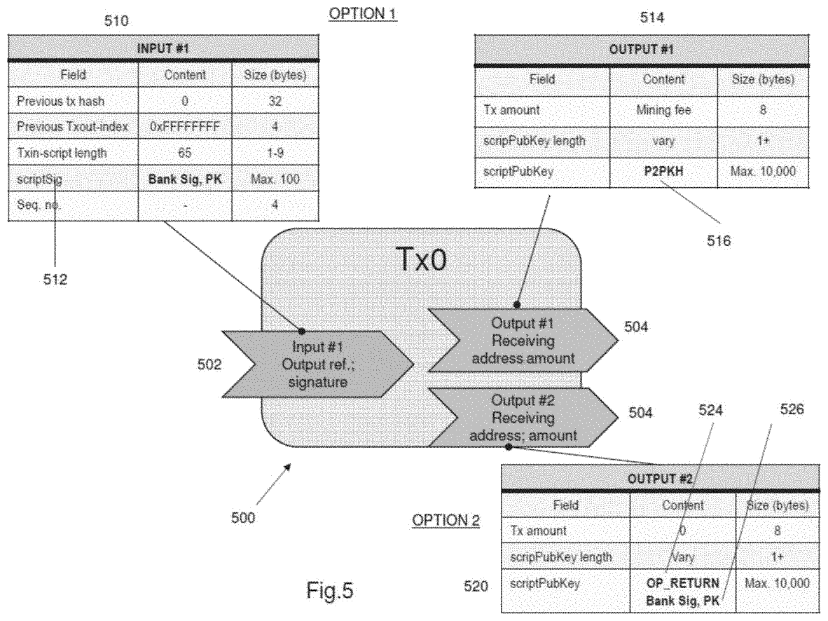

FIG. 5 shows a schematic of an exemplary coinbase transaction within a ledger of transactions. FIG. 5 shows an example modified coinbase transaction 500. FIG. 5 further shows the two options for including the privileged user signature and public keys. A first option is where the input of the coinbase transaction is used when there is a single signature to be included.

A coinbase transaction normally does not have an input and hence the ScriptSig field (or data element) of an input can be filled with arbitrary data. For option 1 where there is only one privileged user with a single signature and a single public key, the privileged user's signature for block validation can be stored in the ScriptSig field. The scriptPubKey filed of a coinbase transaction output is used to store the public key of the privileged user. Exemplary data in the fields for a transaction are illustrated for option 1. For option 1 the input 502 and associated fields are shown in table 510. The input of the transaction includes field scriptSig 512 that has no input since the transaction 500 is a coinbase transaction. The bank signature is shown as Bank Sig. The public key may also be included in the transaction input 502 in the scriptSig 512 field. The public key is determined as part of the transaction and stored in the output 504. The public key 516 is shown as P2PKH is shown in the output table 514. The other fields of the input and output of the transaction 500 are known fields used in blockchain processing.

For option 2 where there are multiple signatures and public keys, the output 504 is shown in table 520 under the heading Option 2. The scriptPubKey field 522 is used to store the privileged user signatures and the public keys associated with the privileged users. The other fields of the output are known and are populated using a known process in the field of blockchain technology. The OP_Return output includes the bank signature 524 and the public keys 526.

In one form, the list of privileged users is embedded into the ledger of transactions (i.e. into the blockchain 140). The coinbase transaction of the genesis block, in the blockchain is used to specific the list or privileged users. The genesis block may be the first block that is mined or validated in a blockchain 140. The genesis block functions as an electronic token, the token including an entry of the plurality of privileged users. The entry may be a list of privileged users or any other format may be used. The token can be checked, by the other user nodes, as part of the verification process.

The list of privileged users can be amended to add or remove privileged users. A node corresponding to the one or more privileged users is configured to amend the list of privileged users. The list of amended of privileged users are transmitted to all the nodes in the network. Each node 102a-102g is configured to update its database 220 to include an updated list or privileged users and/or include an updated list of public keys associated with the privileged users. The database is amended to correspond to the amendments made to the list of the privileged users. The list of privileged users is updated by spending the coinbase transaction and adding the updated list of privileged users in the scriptPubKey data element. By adding the updated list of privileged users in the scriptPubKey block, the privileged users (i.e. validators) are the recipients of the coinbase transaction and the token. Once the new set of privileged users receives the token, the new privileged users are set or defined as the new privileged users on the network 102. In general cryptocurrency operation, such as bitcoin operation, the coinbase transaction is not spent or used. In the present system for controlling an electronic ledger, the coinbase is modified such that it can be spent in order to update the list of privileged users.

The system 100 may comprises a quorum of existing privileged users. The quorum of privileged users may comprise one or more privileged users. Referring to FIG. 1, the quorum of privileged users may comprises the privileged users 102a, 102b. The quorum of privileged users provide permissions to amend or update the list of privileged users. As part of the verification process each node in the network 102 is configured to check the identity of each signature in a block. The signatures are checked against the list of the privileged users in the database 220 associated with each computing device of each node. For a block to be verified, the block must contain at least one signature from at least one privileged user. Preferably the block will include signature from each privileged user that is listed in the list of privileged users.

The criteria for updating a list of privileged users is defined within a set of executable instructions stored in a memory unit of at least the privileged user devices 102a, 102b. The list of privileged users can only be updated if there is a consensus amongst a quorum of privileged users. The consensus may be majority based where a majority, such as for example more than 50%, of the quorum of privileged users ratifies or agrees to a change. Alternatively the consensus may be unanimous, wherein all privileged user has to agree to a change in the list of privileged users. In order to provide a consensus the quorum of privileged users include their signatures on the transaction that includes the new list of privileged users. Generally this new transaction is a coinbase transaction of a new block, and this coinbase transaction is spendable. The signatures of the quorum of privileged users is included in the coinbase transaction as part of a validation process.

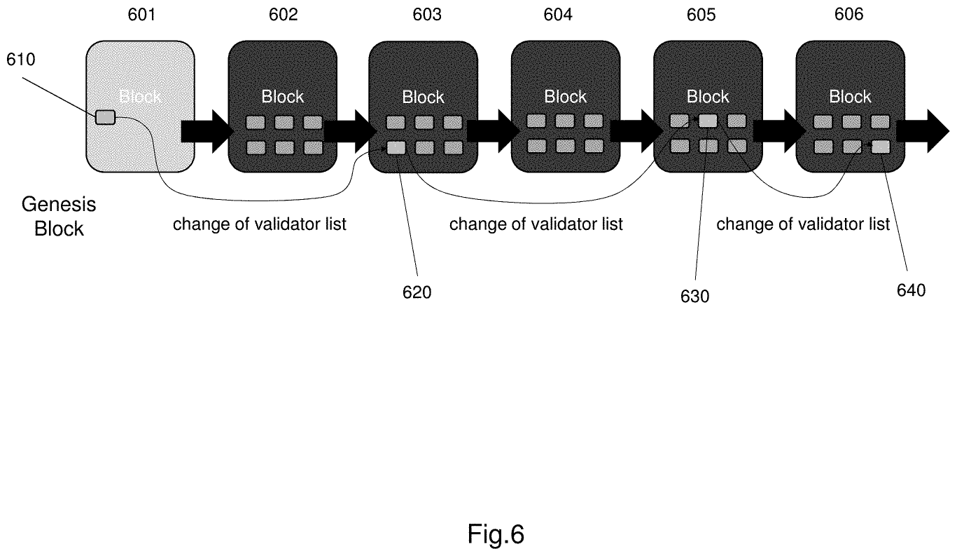

FIG. 6 shows a schematic diagram for updating a record of privileged users within one or more blocks of a ledger of transactions. FIG. 6 shows a plurality of blocks 601, 602, 603, 604, 605 and 606. Each block includes a plurality of transactions, wherein each transaction is represented as a rectangle within the block. The blocks 601-606 together form the electronic ledger of transactions i.e. a block chain. The blocks are arranged in chronological order. The first block 601 is defined as the genesis block of the blockchain. As shown in FIG. 6 the coinbase transaction 610 of the first block 601 (i.e. the genesis block) includes a list of privileged users. The list of privileged users can be updated by including new privileged users in the output of the coinbase transaction i.e. in the scriptPubKey element. The coinbase transaction 610 is spent by the network nodes and included as a new coinbase transaction 620 in a further block once the update to the list of privileged users has been approved by a quorum of privilegd users. FIG. 6 shows further transactions 630 and 640 that include an updated list of privileged users and the further transactions being included within their own blocks. Each transaction that includes a list of updated privileged users forms a coinbase transaction of a separate block. Each new block is mined or verified by the nodes in the network. The database associated 220 at each node is updated every time the network nodes process a block that includes an updated coinbase transaction.

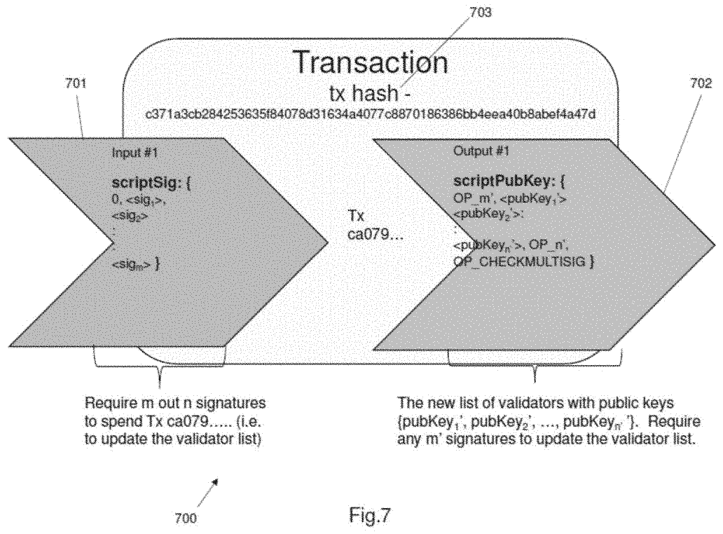

The signatures from the quorum of privileged users is implemented through an m-out-of-n multi signature protocol. The initial list of privileged users and privileged user public keys are embedded as recipients in the coinbase output for a coinbase transaction. The privileged users embedded in the output are the new privileged users that are supposed to receive the updated list. The list of recipients are embedded in the scriptPubKey element of the transaction. FIG. 7 an example input and output for a new transaction to update a list of privileged users. FIG. 7 shows a coinbase transaction of a block that includes an updated list of privileged users. The coinbase transaction 700, shown in FIG. 7, may be a coinbase transaction of a genesis block within a blockchain (i.e. an electronic ledger of transactions). The coinbase transaction 700 includes an input 701 and an output 702. The input 701 and output 702 comprise a plurality of data elements. Each data element may be a string or a collection of strings of electronic data. The transaction 700 further includes a transaction hash 703 labelled tx hash. The transaction 700 is labelled ca079 which is the label of the particular transaction in a blockchain. The input 701 comprises a signature script labelled scriptSig that includes signatures of m out of n privileged users. The m out of n may be defined as more than 50% i.e. wherein more than 50% of the privileged users validate the transaction by adding their signatures in order to update the list of privileged users. The output includes a list of recipients that corresponds to a list of updated privileged users. The output includes a new list of privileged users with associated public keys. This data is included in the scriptPubKey data element and also may include an indication that the signatures of the privileged users. If the transaction has been validated an OP_CHECKMULTISIG script is run to check if the transaction is validated. The list of privileged users is updated in the manner described above and the new list is transmitted to the new privileged users as the transaction is spent by the new recipients. The transaction is included in a block that is mined (i.e. verified) by the nodes in the network. As part of the verification process the other users (i.e. other user devices) in the network update their respective databases to include the updated list of privileged users. At least m signatures from privileged users are required to spend a coinbase transaction that includes a new list of privileged users. The inclusion of the privileged user signatures in the coinbase transaction also make the genesis block of the blockchain spendable. The genesis block being spendable within the network allows the genesis block to include any updates to a list privileged users.

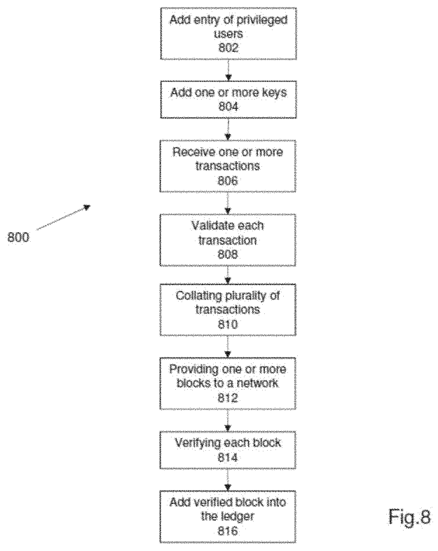

FIG. 8 shows an exemplary method of controlling a ledger of transactions 800. The ledger of transactions is an electronic ledger of transactions. The electronic ledger may exist as a data file and can be electronically transmitted to one or more computers within a network. The method 800 is a computer implemented method of controlling an electronic ledger of transactions. In particular the computer implemented method of controlling an electronic ledger of transactions 800 comprises converting a public ledger of transactions into a private ledger of transactions. In a private ledger only a set of privileged users can add transactions or approve adding transactions. Without some confirmation or input from one or more privileged users, no transactions can be added into the ledger of transactions. As discussed earlier the electronic ledger of transactions is a blockchain. The blockchain comprises a plurality of blocks and wherein the blocks comprise a plurality of transactions being collated together to form a block. Referring to FIG. 8, the method of controlling a ledger of transactions 800 comprises step 802. Step 802 comprises adding an entry of one or more privileged users into the ledger of transactions, wherein the entry is embedded within the ledger of transactions. Step 804 comprises adding one or more keys associated with the one or more privileged users into an entry in the ledger of transactions. Adding the one or more keys and the entry of the one or more privileged users to the ledger of transactions, converts the ledger of transactions from a non permissioned ledger into a permissioned ledger. In a permissioned ledger only the one or more privileged users defined in the ledger are allowed to validate a transaction to be added into the ledger of transactions. Any transaction that is to be recorded into the electronic ledger has to be checked and validated by one or more of the privileged users prior to including the transaction in the ledger.

The method further comprises the step 806. Step 806 comprises receiving one or more transactions by the one or more privileged users. Step 808 comprises validating each transaction by one or more privileged users. Preferably each transaction is validated either by a majority or by all of the privileged users. Step 810 comprises collating the plurality of validated transactions into a block, wherein the lock comprises a plurality of transactions and a digital signature from one or more privileged users. The block may also comprise one or more public keys, wherein each key of the one or more public keys is associated with the one or more privileged users. In one example all the public keys associated with each privileged user that included a digital signature are included in the block. Alternatively at least one key associated with each privileged user is included in the block.

The method further comprises step 812. At step 812 comprises providing one or more blocks to a network of a plurality of nodes within a computer network. Each block comprises a plurality of validated transactions. Each node comprises a computer or computing device. Step 812 may alternatively comprise electronically transmitting one or more validated transactions to a plurality of nodes within a computer network. Step 814 comprises verifying each block. Each node is configured to verify each block that is received by the node. Each node is configured to execute a mathematical protocol to verify each block or transactions within each block. As part of the verification process each node is configured to check if each block or transaction includes a valid electronic signature or signature associated with one or more of the privileged users. Each node may also be configured to determine if one or more public keys associated with the one or more privileged users are included in the block, as part of the verification process. Step 816 comprises adding a verified block into an electronic ledger of transactions. The electronic ledger of transactions is a blockchain that includes a record of transactions that have occurred in chronological order. The mathematical protocol or algorithm is known and comprises determining a hash based on a nonce in a block. Each computing device corresponding to a node is configured to perform one or more mathematical functions to solve an equation that results in a number. If the number matches a hash of the block the block is verified. The mathematical protocol can be any known protocol used in electronic currency processing or proof of work processing of transactions such as processing bitcoin transactions. In one form the mathematical protocol is a bitcoin processing protocol.

In one form the digital signature corresponding to the one or more privileged users is included in at least a first transaction of a block. The first transaction may also include the one or more keys associated with the one or more privileged users. In one form each privileged user may use a single public key. In another form each privileged user may use multiple public keys that may be embedded into a transaction or block. The entry of a privileged user comprises a list of plurality of privileged users wherein the list may further may define differing levels of authority of each privileged user.

In one form the validation step may comprise the privileged users with the highest authority levels including a signature to validate a transaction and privileged users with lower authority levels may only be required to validate transactions that are identified as corresponding to their authority level. In this form each transaction may have an importance or authority level associated with it, and the privileged users corresponding to the importance or authority level of the particular transaction are configured to validate the specific transaction.

In one form the electronic ledger of transactions is a blockchain that is used to keep a record of bitcoin transactions. In one form the method 800 is used to track bitcoin transactions across a computer network and the method 800 is used to convert a non permissioned bitcoin blockchain to a permissioned bitcoin block chain. In other forms the method 800 can be used to control an electronic ledger that tracks transactions associated with any other electronic currency or any other transactions related to the transfer of digital property.

In one form a non transitory computer readable medium comprises a set of executable instructions, causing an electronic processor to perform the steps of method 800, when the processor executes the stored instructions. The non transitory computer readable medium may be a memory unit associated with one or more of the computer devices in the network 102. The processor may be an electronic processor that is part of each computer device in the network 102. Steps 802 to 810 may be executed by the computing device corresponding to the privileged users 102a, 102b.

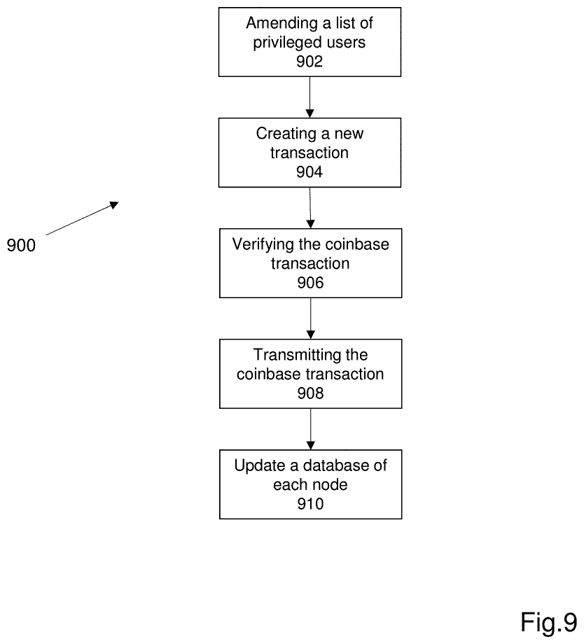

FIG. 9 shows a method of amending a list of privileged users 900. The method of amending a list of privileged users 900 comprises step 902. Step 902 comprises amending a list of privileged users by adding or removing one or more privileged users. Step 904 comprises creating a new transaction that includes the amended list of privileged users. The new transaction is a coinbase transaction of a new block, and wherein the new block comprises the amended list of privileged users. Step 906 comprises verifying the coinbase transaction that includes the amended list of privileged users. The step of verifying the coinbase transaction and amended list of privileged users comprises including one or more signatures associated with a group of quorum of privileged users (i.e. validators). Step 908 comprises transmitting the coinbase transaction to a computer network comprising a plurality of nodes. Each node comprises a computer device corresponding to the node. Step 910 comprises updating a database of each node with a new list of privileged users and a new set of public keys. The database includes a record of privileged users and/or a list of the public keys associated with each privileged user.

In one form a non transitory computer readable medium comprises a set of executable instructions, causing an electronic processor to perform the steps of method 900, when the processor executes the stored instructions. The non transitory computer readable medium may be a memory unit associated with one or more of the computer devices in the network 102. The processor may be an electronic processor that is part of each computer device in the network 102.

The present method is advantageous because it provides a method and framework to convert a non permissioned electronic ledger of transactions into a permissioned electronic ledger of transactions. The electronic ledger of transactions is created using a proof of work method i.e. wherein the transactions and blocks of transactions are verified by all the nodes in a network. The nodes in the network receive a copy of each transaction, mathematically process the transaction and verify if the transaction has taken place. If all or a majority of nodes verify a transaction it is added to the ledger, providing the ledger has been validated by one or more privileged users. As part of the verification process the nodes in the network also check if each transaction includes an appropriate digital signature from the one or more privileged users to ensure the transaction has been validated. This method allows for high immutability of transactions and leverages current methods of verifying transactions using a proof of work methodology, while providing an element of control with having a permissioned ledger where one or more privileged users (i.e. validators) have control on what transactions are included.

The presently described system and method for controlling an electronic ledger of transactions is also advantageous because privileged users can easily be included and amended. Further signature is easy to include and if a block does not include a valid signature or signatures, the block is dropped by all nodes in the network. Further the proof of work protocol used during verification of transactions is off loaded to other users in the network thereby using the collective processing power of the network. Further the verification of transactions is faster and requires less processing power and time since the nodes in the network only need to verify validated transactions i.e. transactions that have been validated by privileged users. Transactions that are not validated are not verified and simply discarded thereby reducing the processing requirements for each node.

The method of updating a list of privileged users is safe from attackers or adversaries because for a user to be added to the list of privileged users, a quorum of privileged users is required to agree on any change. Therefore an adversary that wants to be included on the list of privileged users, would need to get approval from or at least manipulate all the devices associated with the privileged users in the quorum of privileged users. Therefore the current system is inherently safer from attacks due to the low probability that an adversary can forge signatures of all privileged users and update the list of privileged users.

Although not required, the embodiments described with reference to the Figures can be implemented to file an application programming interface (API) or as a series of libraries for use by a developer or can be included within another software application, such as a terminal or personal computer operating system or a portable computing device operating system. Generally, as program modules include routines, programs, objects, components and data files the skilled person assisting in the performance of particular functions, will understand that the functionality of the software application may be distributed across a number of routines, objects or components to achieve the same functionality.

It will also be appreciated that the methods and systems of the present invention are implemented by computing system or partly implemented by computing systems than any appropriate computing system architecture may be utilized. This will include stand-alone computers, network computers and dedicated computing devices. Where the terms “computing system” and “computing device” are used, these terms are intended to cover any appropriate arrangement of computer hardware for implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

While the invention has been described with reference to a number of preferred embodiments it should be appreciated that the invention can be embodied in many other forms.

Modifications and variations as would be apparent to a skilled addressee are deemed to be within the scope of the present invention.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

1. A computer implemented method for controlling a ledger of transactions, the method comprising the steps of:
adding an entry of one or more privileged users into the ledger of transactions, the entry being embedded within the ledger of transactions,
adding one or more keys associated with the one or more privileged user to the ledger of transactions,
wherein the ledger of transactions is a non permissioned ledger and;
wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions.

2. A computer implemented method for controlling a ledger of transactions in accordance with claim 1, wherein the entry comprises a list of a plurality of privileged users, and wherein the plurality of privileged users can validate a transaction to be added into ledger of transactions.

3. A computer implemented method for controlling a ledger of transactions in accordance with claim 1, wherein the ledger of transactions includes a record of all transactions occurring across a distributed network, the transactions are ordered in chronological order within the ledger of transactions,
the ledger of transactions is a blockchain, wherein the blockchain comprises a plurality of blocks, wherein each block includes a record of one or more transactions and a date stamp, the blocks being arranged in the blockchain in a chronological order based on the date stamp.

4. A computer implemented method for controlling a ledger of transactions in accordance with claim 1, wherein the entry comprises a list of a plurality of privileged users, the entry further comprises a level of authority of each of the plurality of privileged users.

5. A computer implemented method for controlling a ledger of transactions in accordance with claim 1, wherein comprises the steps of;
receiving one or more transactions, each transaction being defined in a transaction request from a user, the transactions being received by the one or more of the privileged users,
validating each transaction, wherein each transaction being validated by at least one privileged user of the one or more privileged users,
collating a plurality of validated transactions into a block, wherein the block comprises at least a plurality of transactions and a digital signature from the at least one privileged user of the one or more privileged users.

6. A computer implemented method for controlling a ledger of transactions in accordance with claim 1, wherein the digital signature of the at least one privileged user being included in at least a first transaction of the block and including the one or more keys associated with the one or more privileged users, and wherein at least the digital signature is embedded within an unused portion of the transaction.

7. A computer implemented method for controlling a ledger of transactions in accordance with claim 3, wherein the method comprises the additional steps of:
providing one or more blocks to a network of a plurality of nodes,
two or more of the plurality of nodes from the network verifying each block, each node configured to execute a mathematical protocol to verify each block, the network comprising nodes corresponding to the privileged users and other users,
adding a verified block into the blockchain.

8. A computer implemented method for controlling a ledger of transactions in accordance with claim 5, wherein the step of verifying each block comprises each node checking that the block includes a valid electronic signature and checking if one or more keys included in the block relates to one or more of the privileged users included in the ledger of transactions.

9. A computer implemented method for controlling a ledger of transactions in accordance with claim 1, wherein the ledger of transactions is a blockchain, the blockchain comprises a genesis block, the genesis block functioning as an electronic token, the token including an entry of the plurality of privileged users and wherein the entry is a list of the plurality of privileged users.

10. A computer implemented method for controlling a ledger of transactions in accordance with claim 2, wherein the method comprises amending a the list of the privileged users to add or remove a privileged user from the list of privileged users, wherein a node corresponding to the one or more privileged users is configured to amend the list of privileged users,
transmitting the amended list of privileged users to all the nodes in the network,
updating a database of keys at each node within the network, wherein the database of keys includes a record of an identity of the current privileged users or public keys of a current list of privileged users and wherein the database of keys is updated to correspond to the amendments made to the list of privileged users.

11. A computer implemented method for controlling a ledger of transactions in accordance with claim 10, wherein the step of verifying a block further comprises the additional step of a node checking the identity of a signature and the identity of the keys included in the block, and wherein the identity of the signature and identity of keys being related to the record in the database stored at the nodes.

12. A computer implemented method for controlling a ledger of transactions in accordance with claim 10, wherein the step of amending the list of privileged users comprises the additional steps creating at least a new transaction that includes the amended list of privileged users,
transmitting the new transaction across the network of nodes, and wherein each node is configured to execute the step of updating the database at each node as the transaction is received at each node.

13. A computer implemented method for controlling a ledger of transactions in accordance with claim 12, wherein the new transaction is a coinbase transaction of a new block, and wherein the new block including the amended list of privileged users is transmitted to the nodes in the network.

14. A computer implemented method for controlling a ledger of transactions in accordance with claim 13, wherein the one or more keys added to the entry in the ledger of transactions are public keys that correspond to the one or more privileged user,
the coinbase transaction is spendable by a privileged user based on one or more signatures within the coinbase transaction, and;
the coinbase transaction specifying a threshold or quorum required to validate a transaction or update the list of privileged users.

15. A system for controlling a ledger of transactions, the system comprising:
one or more privileged user devices, each device being associated with a privileged user, the one or more privileged user devices configured to add an entry of one or more privileged users into the ledger of transactions, the entry being embedded within the ledger of transactions,
the one or more privileged user devices configured add one or more keys associated with the one or more privileged user to an entry in the ledger of transactions,
wherein the ledger of transactions is a non permissioned ledger, and wherein adding the one or more keys and the entry to the ledger of transactions coverts the non permissioned ledger of transactions into a permissioned ledger of transactions, such that only the one or more privileged user defined in the entry can validate a transaction to be added into the ledger of transactions.

16. A system for controlling a ledger of transactions in accordance with claim 15, wherein the entry comprises a list of a plurality of privileged users, and wherein the plurality of privileged user devices can validate a transaction to be added into the ledger of transactions.

17. A system for controlling a ledger of transactions in accordance with claim 15, wherein the ledger of transactions includes a record of all transactions occurring across a distributed network, the transactions are ordered in chronological order within the ledger of transactions,
the distributed network comprising a plurality of computing devices, each computing device being a node within the network and;
the ledger of transactions is a blockchain wherein the blockchain comprises a plulrality of blocks, each block includes a record of one or more transactions and a data stamp.

18. A system for controlling a ledger of transactions in accordance with claim 15, wherein the entry comprises a list of a plurality of privileged users, the entry further comprises a level of authority of each of the plurality of privileged user.

19. A system for controlling a ledger of transactions in accordance with claim 15, wherein the one or more privileged user devices receiving one or more transaction requests from a user wherein each transaction request includes one or more transactions,
the one or more privileged user devices configured to validate each transaction, wherein each transaction being validated by at least one privileged user device of the one or more privileged users device,
the one or more privileged user devices configured to collate a plurality of validated transactions into a block, wherein the block comprises a plurality of transactions and a digital signature from the one or more privileged users that validated the transaction.

20. A system for controlling a ledger of transactions in accordance with claim 19, wherein the privileged user device configured to include digital signature of the at least one privileged user being included in at least a first transaction of the block and the privileged user device configured to include the one or more keys associated with the one or more privileged users that validated the first transaction, and wherein at least the digital signature is included in an unused portion of the first transaction.

21. A system for controlling a ledger of transactions in accordance with claim 17, wherein the one or more privileged user devices are configured to provide the one or more blocks to a network of a plurality of nodes, the network comprises nodes that correspond to the privileged user devices and nodes that correspond to other user devices, wherein the privileged user devices and other user devices,
each node comprises a computing device,
two or more of the plurality of nodes from the network configured to verify each block received in the network, and each computing device corresponding to each node configured to execute a mathematical protocol to verify each block,
the one or more nodes in the network configured to add a verified block into the blockchain.

22. A system for controlling a ledger of transactions in accordance with claim 19, wherein each computing device associated with the node within the network configured to check that the block includes a valid electronic signature, each node within the network configured to check if one or more keys included in the block relates to one or more of the privileged users.

23. A system for controlling a ledger of transactions in accordance with claim 15, wherein the ledger of transactions is a blockchain, the blockchain comprising a plurality of blocks being arranged in a chronological order, the blockchain is an electronic ledger of transactions, the blockchain comprising a genesis block, wherein the genesis block functions as an electronic token, the token including an entry of the plurality of privileged users and wherein the entry is a list of the plurality of users.

24. A system for controlling a ledger of transactions in accordance with claim 23, wherein the electronic token being included in the blockchain, the computing devices associated with the other users in the network configured to receive the electronic token and the computing devices associated with the other users in the network configured to verify each block.

25. A system for controlling a ledger of transactions in accordance with claim 16, wherein one or more privileged user devices configured to amend the list of the privileged users by adding or removing a privileged user from the list of privileged users,
the one or more privileged user devices configured to transmit the amended list of privileged users to all the nodes in the network,
the other user devices within the network configured to updated a database of keys, wherein each other user device comprises an associated database of keys that includes a record of an identify of the current privileged users and/or public keys associated with the current list of privileged users, and wherein the database of keys is updated to correspond to the amendments made to the list of privileged users.

26. A system for controlling a ledger of transactions in accordance with claim 25, wherein the computing device corresponding to a node configured to check the identity of a signature and the identity of the keys included in the block as part of verifying a block, and wherein the identity of the signature and identity of keys being related to the record in the database stored on a computing device corresponding to a node.

27. A system for controlling a ledger of transactions in accordance with claim 25, wherein one or more privileged user devices being configured to amend the list of privileged users by creating a new transaction that includes the amended list of privileged,
the one or more privileged user devices configured to transmit the new transaction across the network of nodes, wherein each computing device corresponding to a node in the network configured to updated an associated database as the transaction is received at each computing device.

28. A system for controlling a ledger of transactions in accordance with claim 27, wherein the new transaction is a coinbase transaction of a new block, and wherein the new block including the amended list of privileged users is transmitted to the nodes in the network.

29. A system for controlling a ledger of transactions in accordance with claim 28, wherein the one or more keys added to the entry in the ledger of transactions are public keys that correspond to the one or more privileged user,
the coinbase transaction is spendable by a privileged user via a privileged user device based on one or more signatures within the coinbase transaction, and;
the coinbase transaction specifying a threshold or quorum required to validate a transaction or update the list of privileged users.
